(19) United States
(12) Patent Application Publication
(10) Pub. No.: US 2026/0285522 A1
(43) Pub. Date: Sep. 24, 2026

(54) AN APPARATUS FOR COLLECTING ARTICLES FROM A FIRST POSITION, IN WHICH THE ARTICLES ARE ARRANGED VERTICALLY, AND TRANSFERRING THE ARTICLES INTO A SECOND POSITION IN WHICH THE ARTICLES ARE ARRANGED HORIZONTALLY, AND VICE VERSA

(71) Applicant: MARCHESINI GROUP S.P.A., PIANORO (BO) (IT)

(72) Inventor: Simone NANNETTI, GRIZZANA MORANDI (BO) (IT)

(73) Assignee: MARCHESINI GROUP S.P.A., PIANORO (BO) (IT)

(21) Appl. No.: 19/476,184

(22) PCT Filed: Apr. 12, 2024
(86) PCT No.: PCT/IB2024/053595

§ 371 Date: Oct. 17, 2025

(30) Foreign Application Priority Data
Apr. 20, 2023 (IT) 102023000007713

(51) Int. Cl. B65B 35/58

(52) U.S. Cl. CPC B65B 35/58

(57) ABSTRACT

The apparatus for collecting articles from a first position, wherein the articles are arranged vertically, and transferring the articles into a second position wherein the articles are arranged horizontally, and vice versa, comprises: a first vertical bearing column and a second vertical bearing column, facing one another; at least a gripping element; a support element of the gripping element arranged in the manoeuvring space between the two vertical bearing columns with the respective longitudinal axis, transversally thereto. The apparatus comprises a first movement unit, mounted on the first vertical bearing column, and a second movement unit, mounted on the second vertical bearing column, configured and activatable to move together the support element: between a first operating position, in which the at least a gripping element is opposite to at least a respective article in the first position.

### FIELD OF THE INVENTION

The present invention relates to the technical sector relating to the packaging of products, for example in solid, liquid, powder or granular form, internally of relative packages which are then to be inserted into boxes or containers.

### DESCRIPTION OF THE PRIOR ART

In this sector, according to the type of products and the structure of the packaging machines, the packages, once filled with relative products, can be made available, arranged vertically, at an outlet station of the machines, from which the packages are to be picked up to be transferred, arranging them horizontally, on a transport means for successive transfer thereof to a boxing machine or a carton boxing machine, designed for inserting the packages into relative boxes or cartons.

An example this type of packaging machine is constituted by the vertical packaging machines to realise packages known as stickpacks.

Stickpacks are packages obtained from portions of film made of a heat-weldable material, cut from a reel, which are wound about the product to be packaged to form tubular elements, which are then heat-welded longitudinally and at the two heads, thus forming tubular sachets sealed on three sides.

The vertical packaging machines have an outlet station in which the stickpacks are infed in a vertical configuration.

To carry out the transfer thereof onto a transport means, the stickpacks must be rotated in such a way as to arrange them from the vertical configuration to a horizontal configuration, so as to be deposited on the transport means.

A first technique at present in use includes the use of gripping elements, of the suction type, which are activated by a movement system comprising both linear motors and electric motors responsible for moving the gripping elements respectively in a translation movement and then in rotation, in order to carry out the pick-up of the stickpacks, the moving away thereof from the outlet station, a rotation thereof so as to arrange them in a horizontal configuration, and then the successive vertical translation thereof so as to be deposited on the transport means.

The use of linear motors and electric motors, and the relative drive transmission elements (for example arms, levers, cams, etc.) used for the movement of the gripping elements, requires a certain dimension, in terms of both the space required for installation thereof and of the manoeuvring space necessary for allowing the movement of the gripping elements from the outlet station of the packaging machine to the transport means.

This leads, consequently, also to the need to position the transport means at a certain distance from the outlet station, which is therefore difficult to access, and view, by an operator, should operations for control and/or maintenance be necessary.

Further, these systems for the movement of the gripping elements incur a relevant cost.

Further, in a case of size change (dimensions) of the stickpacks, it is necessary to proceed to adjustments of the position of the motors and movement system of the gripping elements, which require time and which can also be not of simple and immediate execution.

Another technique at present in use for carrying out the transfer, with a relative rotation, from a vertical configuration to a horizontal configuration, of the stickpacks from the outlet station from the packaging machine to the transport means, includes the use of slides and conveying chutes, appropriately inclined and having a parabolic shape, which direct and convey the stickpacks to special hatches or hoppers for successive release thereof onto the transport means.

However this mode of transfer has some drawbacks.

Firstly, the stickpacks are left to fall along the slides in free fall by force of gravity and in an uncontrolled way, and this can cause some tumbling or jamming of the packages.

Further, the packages, in free fall, can also take on various orientations along the slides and thus be unloaded onto the transport means not correctly positioned in the required position for the transfer thereof to the boxing machines or carton boxing machines.

Further, the slides have to be designed in order to be adequate to allow for the free fall of stickpacks of various formats, sizes and weight, and therefore these can have a vertical extension and an inclination that are considerable, with a consequent large distancing of the transport means from the outlet station of the packaging machine.

In other types of packaging machine, such as for example tube filling machines, the packages, in this constituted by small tubes still to be filled, can be transported in a horizontal configuration from a relative transport means and then be picked up so as to be arranged in a vertical configuration for the purpose of filling them.

In this case too, the solutions at present used to carry out the pick-up of the tubes in a horizontal configuration from the transport means, pick up, rotating them to arrange them in a vertical configuration and positioning them at the station designated to fill them, include the use of linear activating motors and electric motors for activating a movement system of gripping means which require an adequate space for installation and manoeuvring, and a high cost.

### SUMMARY OF THE INVENTION

The aim of the present invention is therefore to provide a novel apparatus for collecting articles from a first position, in which the articles are arranged vertically, and for transferring the articles into a second position in which the articles are arranged horizontally, and vice versa, able to obviate the drawbacks present in the prior-art apparatuses described in the foregoing.

In particular, an aim of the invention is to provide an apparatus for collecting articles from a first position, in which the articles are arranged vertically, and transferring the articles into a second position in which the articles are arranged horizontally, and vice versa, so as to have a modest size, so as not to require an excessive manoeuvring space, and so as to be suited to operate even in a case of size change of the articles without having to carry out regulating or adjustments.

In other words, the apparatus of the invention, without the need to have to perform regulation, adjustments or replacement of parts, and with a modest size, is suitable for use both for carrying out transfers of articles from a first position, in which the articles are arranged vertically, to a second position in which the articles are arranged horizontally, such as for example for transferring stickpacks from the outlet station of a packaging machine, in which they are arranged vertically on a transport means, in which they are arranged horizontally, and also for carrying out transfers of articles from a first position, in which the articles are arranged horizontally, and a second position in which the articles are arranged vertically, such as for example for transferring tubes from a transport means, in which the tubes are arranged horizontally, to a filling station in which the tubes are to be arranged vertically so as to carry out the filling thereof.

The above aims are attained according to the claims.

The characteristics of a preferred, but not exclusive, embodiment of the apparatus proposed by the present invention will be described in the following with reference to the appended tables of drawings, in which the apparatus, without constituting any limiting or exclusive character, has been illustrated as being used for carrying out the transfer of articles, being stickpacks, from a first position in which they are arranged vertically, to a second position in which they are arranged horizontally on a transport means.

### BRIEF DESCRIPTION OF THE DRAWINGS

FIG. 1 illustrates, according to a schematic perspective view, the apparatus for collecting and transferring articles from a first position, in which the articles are arranged vertically in a second position in which the articles are arranged horizontally, and vice versa, object of the present invention;

FIG. 2 illustrates, schematically and with a perspective view, some significant components of the apparatus of the invention in a first possible operating configuration.

FIG. 3 illustrates, schematically and with a perspective view, some significant components of the apparatus of the invention in a second further possible operating configuration.

FIG. 4 illustrates, in a perspective exploded view, some particularly significant components of the apparatus of the invention.

FIG. 5 illustrates a detail in larger-scale in a perspective view taken from a different angle of some components illustrated in FIG. 5.

FIGS. 6A to 6D schematically illustrate a particularly significant component of the apparatus of the invention, according to various possible modes of activation.

FIGS. 7 to 10 illustrate, in respective schematic and perspective views, an operating sequence of functioning of the apparatus of the present invention for carrying out the pick-up of articles in this case stickpacks, from a first position in which the stickpacks are arranged vertically, and for the subsequent release of the stickpacks, following a rotation thereof, to a second position in which the stickpacks are arranged horizontally on a transport means.

FIGS. 11 to 13 illustrate, according to respective schematic views, the position assumed by some components of the apparatus of the invention during the transfer of the stickpacks from the first position in which they are arranged vertically to the second position in which they are arranged horizontally.

FIGS. 14 to 15 illustrate, in respective perspective views, the movement sequence of the apparatus of the invention, once the stickpacks have been released onto the transport means, so as to return to the first pick-up position in which the stickpacks, to be picked up and transferred to the transport means, are arranged vertically.

### DESCRIPTION OF THE PREFERRED EMBODIMENTS

With reference to the figures of the drawings, reference numeral (100) denotes the apparatus for collecting articles (A) from a first position (PV), in which the articles (A) are arranged vertically, and transfer the articles in a second position (PO) in which the articles (A) are arranged horizontally, and vice versa.

By articles arranged in a position in which they are arranged vertically, it is understood that the articles are positioned with a relative longitudinal axis (or a transversal axis) arranged in a vertical plane or substantially vertical.

For example in the case of stickpacks, which have an elongate shape, it is understood that they are arranged with the relative longitudinal axis on a vertical or substantially vertical plane (such as for example illustrated in the appended figures).

Correspondingly, with articles arranged in a position in which they are arranged horizontally, it is understood that the articles are positioned with a relative longitudinal axis (or a transversal axis) arranged on a horizontal or substantially horizontal plane, such as for example an upper branch of a belt of a transport means, closed loop-wound on relative pulleys having horizontal rotation axes.

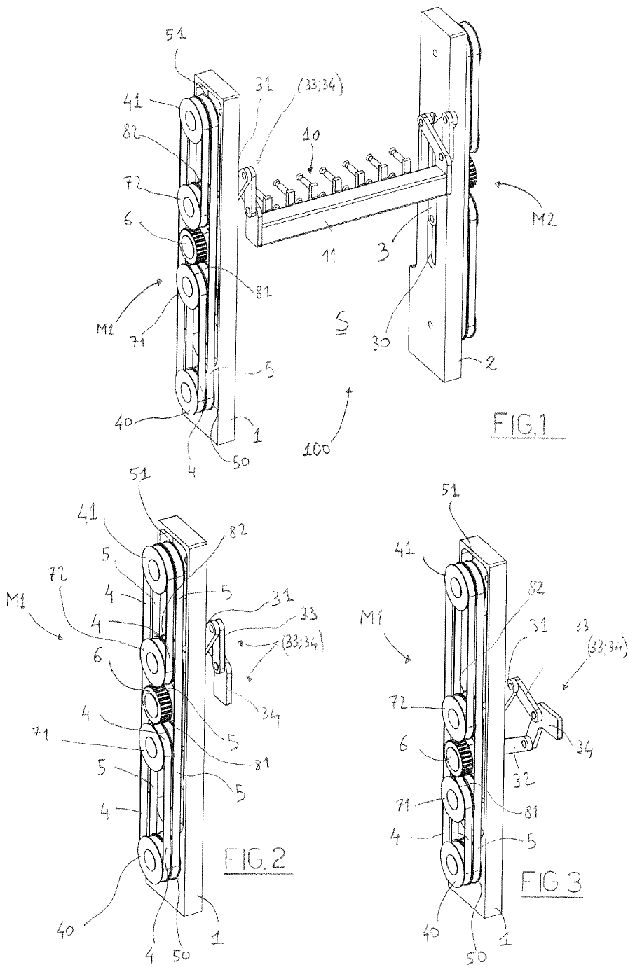

As for example illustrated in FIG. 1, the apparatus (100) comprises a first vertical bearing column (1) and a second vertical bearing column (2), with the first vertical bearing column (1) and the second vertical bearing column (2) being arranged facing one another, for example arranged parallel to one another in such a way as to define a manoeuvring space(S) between them.

The apparatus (100) is provided with at least a gripping element (10), for example having a suction action, which is configured to collect, retain and release a respective article and a support element (11) of the at least a gripping element (10).

The support element (11), having for example an elongate shape in bar form, comprises a longitudinal axis and is arranged in the manoeuvring space(S) between the first vertical bearing column (1) and the second vertical bearing column (2) with the respective longitudinal axis transversally arranged with respect to the first vertical bearing column (1) and to the second vertical bearing column (2).

The apparatus (100) further comprises a first movement unit (M1), which is mounted and disposed on the first vertical bearing column (1), for the movement of the support element (11), and a second movement unit (M2), which is mounted and disposed on the second vertical bearing column (2), for the movement of the support element (11).

In particular, the first movement unit (M1) and the second movement unit (M2) are configured and activatable to move together the support element (11):

between a first operating position (O1), (see for example FIG. 7), in which the at least a gripping element (10) borne by the support element (11) is opposite at least a respective article to be picked up and which is situated in a first position (PV) wherein the article is vertically arranged, for the pick-up of the article (A) by the gripping element (10),

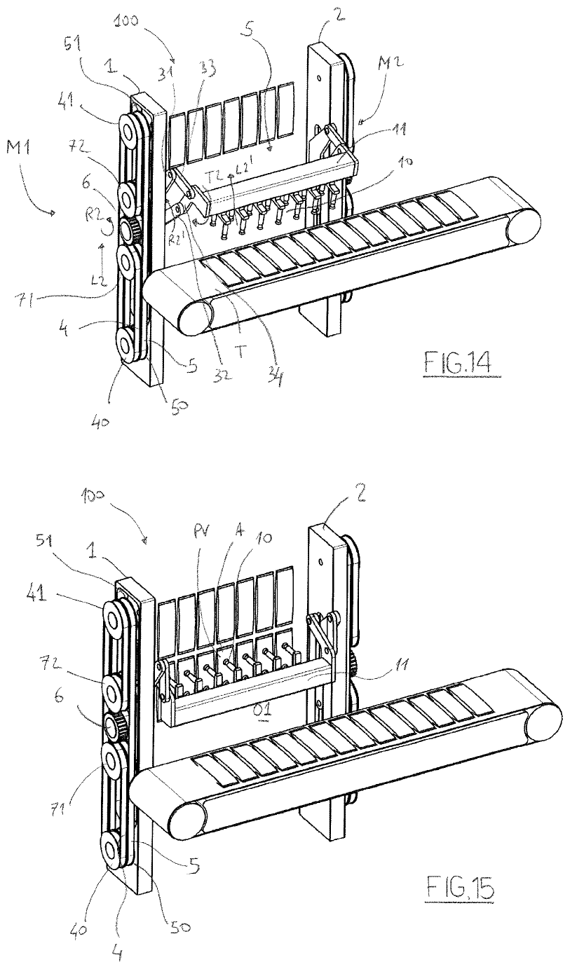

and a second operating position (O2) (see for example FIG. 10) in which the gripping element (10) borne by the support element (11) is opposite a transport means (T) with the article (A) retained by the gripping element (10) being arranged in a second position (PO) and horizontally, for release thereof onto the transport means (T),

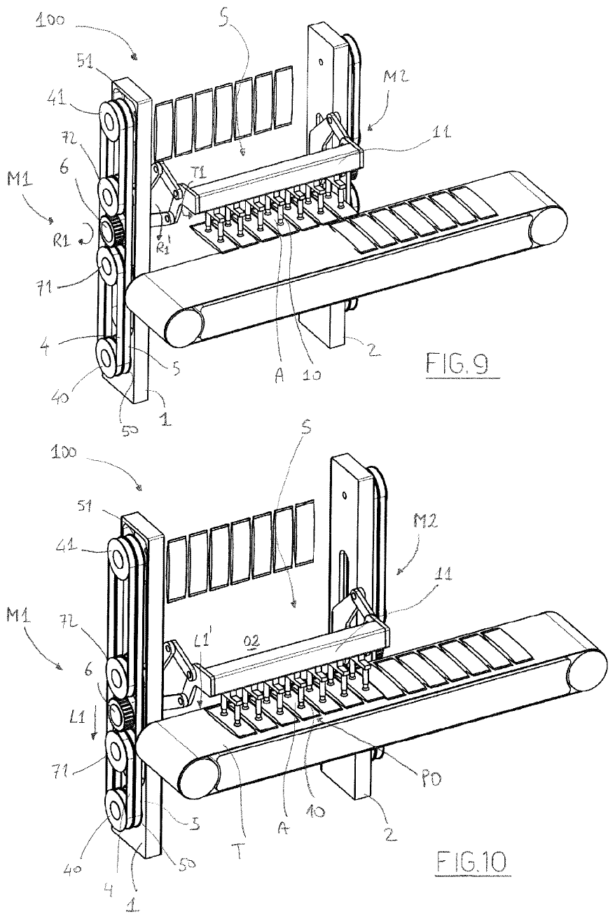

with the first movement unit (M1) and the second movement unit (M2) being configured and activatable to move, together, the support element (11) between the first operating position (O1) and the second operating position (O2), while keeping the support element (11) arranged in the manoeuvring space(S) and causing the support element (11) to perform a rotation about the respective longitudinal axis (see for example FIGS. 8 and 9, or FIGS. 11 and 12) in such a way as to rotate the article (A) retained by the gripping element (10) between a vertical position and a horizontal position, and vice versa.

Owing to this particular structure, with the two vertical bearing columns on which the first and second movement unit of the support element are mounted being arranged and movable, while remaining within the manoeuvring space comprised between the two vertical bearing columns, the apparatus of the invention can easily be positionable directly at the sides of an infeed area of articles in a vertical configuration, from which the articles are to be picked up, as well as also directly flanked to a horizontal transport means, on which the articles are to be released in a horizontal position, or vice versa in order to pick up articles arranged in a horizontal position on the transport means or another infeed device and to release the articles in a second position, still located between the two vertical bearing columns wherein the articles must be arranged vertically.

Both the collecting zone, situated at an articles infeeding station, such as for example the outlet of a vertical packaging machine for the production of stickpacks, and the release area, onto a transport means, remain directly and easily accessible by an operator, if needed.

Further, the transport means can be located directly flanked to the outlet area of the stickpacks, as the apparatus can move the support element of the at least a gripping element in the manoeuvring space comprised between the two vertical bearing columns, thus significantly limiting the overall size.

With reference to the figures, for example in particular in FIGS. 4 and 5, the following includes a description of the further and advantageous characteristics of the apparatus of the invention, as regards the realisation of the first and second movement unit.

The first movement unit (M1) and the second movement unit (M2) are realised in such a way as each to comprise:

a slide (3), which is mounted translatably in a vertical slot (30) realised respectively in both the first vertical bearing column (1) and in the second vertical bearing column (2);

a first member (31), rigidly mounted on the slide (3);

a second member (32), rotatably hinged to the slide (3) according to a respective rotation axis (A);

a lever system (33, 34), which levers are rotatably coupled, on one side, to the first member (31) and to the second member (32), and hinged, on the other side, to the support element (11) of the at least a gripping element (10);

a first belt (4), which is closed loop-wound on a first drive pulley (40) and a first driven pulley (41) which are mounted on the first vertical bearing column (1) and on the second vertical bearing column (2) on opposite sides with respect to the vertical slot (30) (for example the first drive pulley in the figures is illustrated in a lower position with respect to the first driven pulley, though it is also possible to invert the positions thereof);

a second belt (5), which is closed loop-wound on a second drive pulley (50) and a second driven pulley (51) which are mounted on the first vertical bearing column (1) and on the second vertical bearing column (2), on opposite sides with respect to the vertical slot (30) (for example the second drive pulley in the figures is illustrated in a lower position with respect to the second driven pulley, though it is also possible to invert the positions thereof).

In particular, the first movement unit (M1) and the second movement unit (M2), as well illustrated in the exploded view of FIG. 4, are further realised in such a way as each to comprise:

a central cogged pulley (6), rotatably mounted on the slide (3) at the rotation axis (A) of the second member (32) in such a way as to rotate the second member (32) when the central cogged pulley (6) is activated in rotation,

wherein the central cogged pulley (6) is mounted on the slide (3) in a position interposed between the first drive pulley (40) and the first driven pulley (41), and between the second drive pulley (50) and the second driven pulley (51), and wherein the first belt (4) is configured and arranged in such a way as to partially wind on a first side of the central cogged pulley (6), and wherein the second belt (5) is arranged and configured in such a way as to partially wind on a second side of the central cogged pulley (6), opposite the first side on which the first belt (4) partially winds.

With this special arrangement of the two belts with respect to the central cogged pulley, with the apparatus of the invention it is possible to move the support element in the manoeuvring space comprised between the two vertical bearing columns with vertical translations, upwards or downwards, as well as with rotations about the relative longitudinal axis, in a first clockwise direction or in a second anticlockwise direction, such as for example illustrated in figures from 6A to 6D, which are described in detail in the following.

The first drive pulley (40) and the second drive pulley (50) are activatable independently of one another, in any combination of following modes, singly or in any combination thereof.

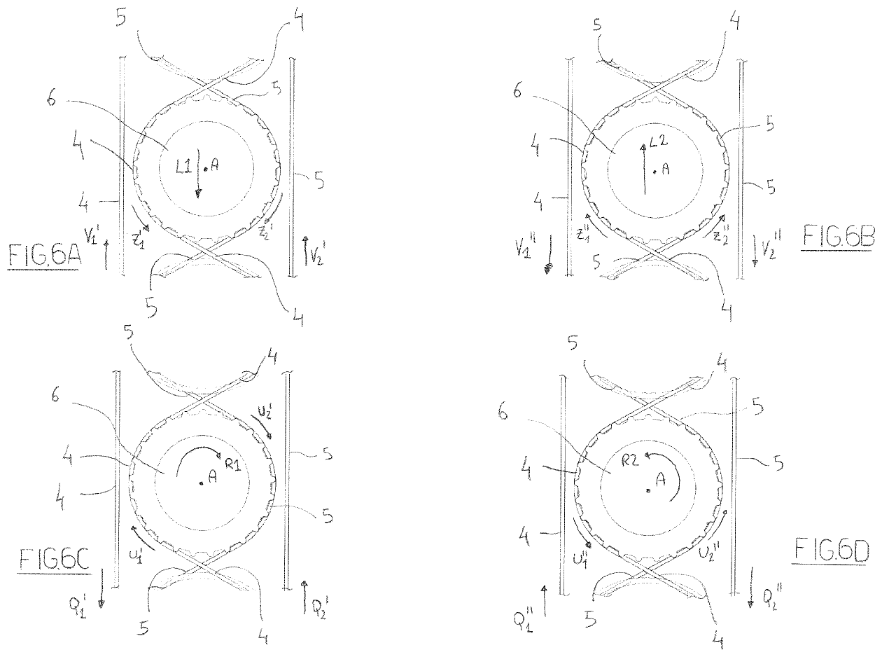

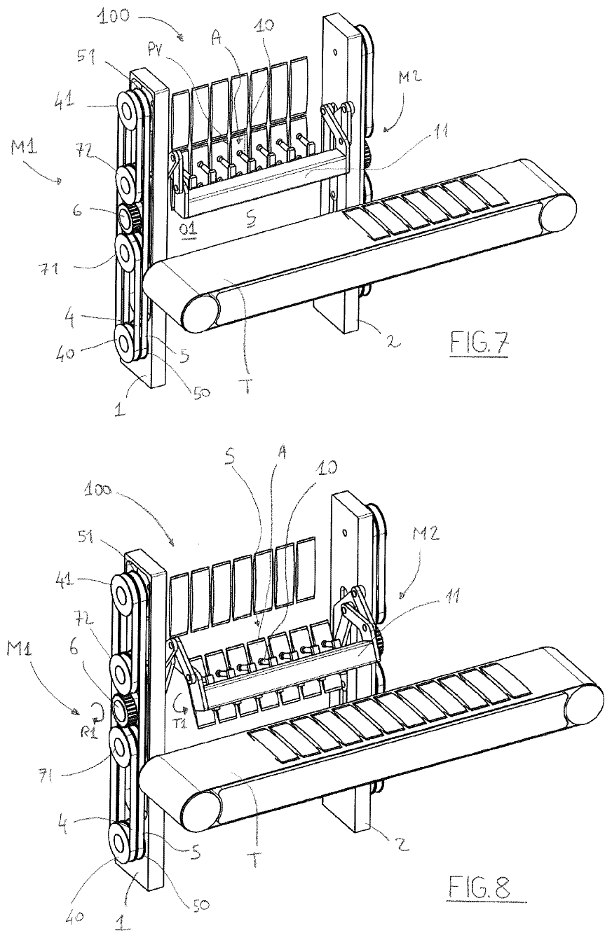

In a first mode, as illustrated in FIG. 6A, the first drive pulley (40) and the second drive pulley (50) are activatable in rotation with respective first opposite rotation directions (V1′, V2′), and with a same rotation velocity.

In FIG. 6A, by way of example, the movement directions of the first belt and second belt are illustrated following the activation in rotation of the two drive pulleys with respective first opposite rotation directions and with a same rotation velocity.

For example, taking FIG. 2 as a reference, the first drive pulley (40) (also mounted in a lower position in the preferred but not exclusive embodiment) for this purpose will be activated in a clockwise rotation direction (looking at the figure) while the second drive pulley (5) (also mounted in a lower position in the preferred but not exclusive example) for this purpose will be activated in an anticlockwise rotation direction, thus generating the movements of the two belts with respect to the central cogged pulley (6) illustrated in FIG. 6A.

In this way, with this mode of activation of the two drive pulleys, the first belt (4) and the second belt (5) wind about the central cogged pulley (6) according to respective first opposite rotation directions (Z1′, Z2′), thus keeping the central cogged pulley (6) stationary, i.e. non-rotating, with respect to the relative rotation axis (A) and with respect to the slide (3), and at the same time pushing the central cogged pulley (6) downwards (L1).

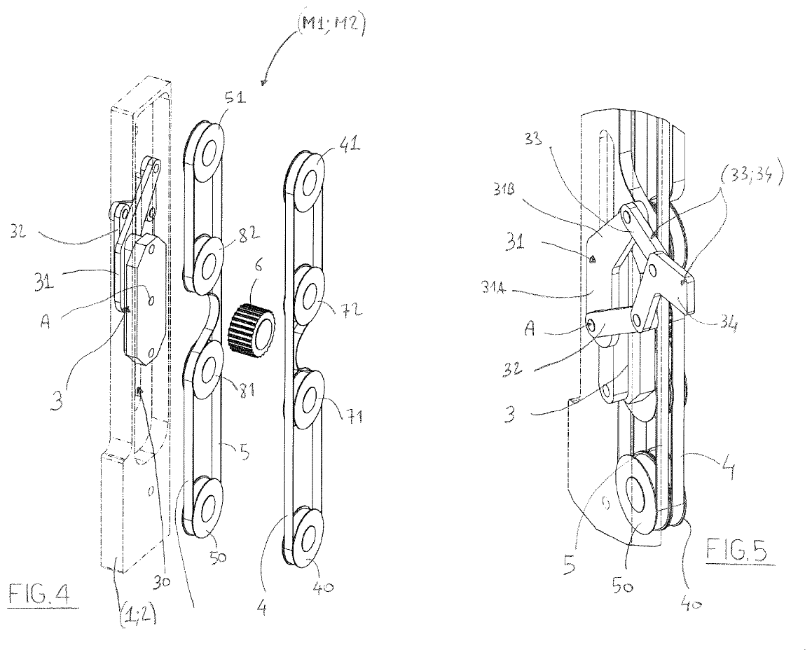

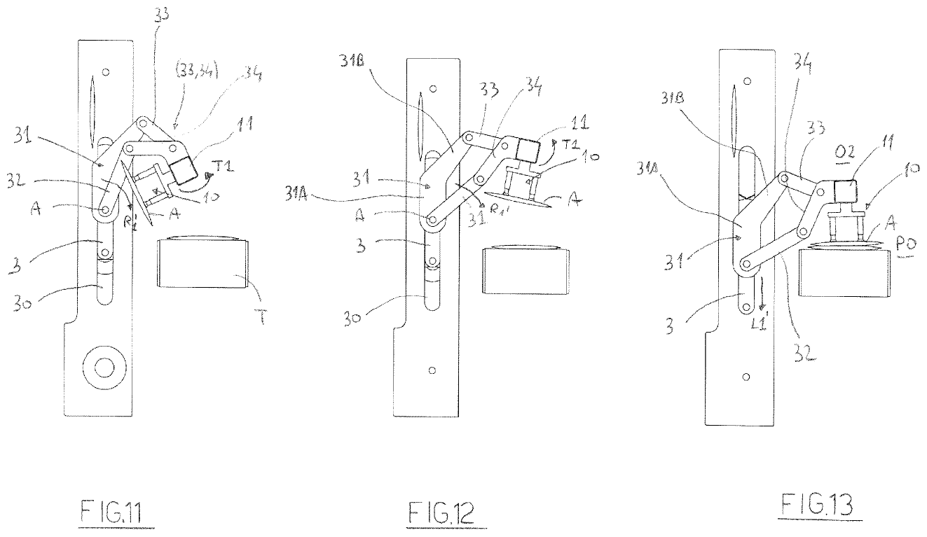

The slide (3) is consequently translated in a downwards direction along the vertical slot (30) present in the first vertical bearing column (1) and in the second vertical bearing column (2), with a respective downwards movement (L1′) of the support element (11) by means of the first member (31) and the lever system (33, 34) (see for example FIG. 3 where the slide (3) is in a lowered position with respect to the position of FIG. 2, or FIG. 10 in which the slide (3) is in a lowered position with respect to the position of FIG. 9, or FIG. 13 in which the slide (3) is in a lowered position with respect to the positions of FIGS. 11 and 12).

On the basis of a second possible mode of activation, for example illustrated in FIG. 6B, the first drive pulley (40) and the second drive pulley (50) are activatable in rotation with respective second opposite rotation directions (V1″, V2″), and with a same rotation velocity.

In this case too, in FIG. 6B, by way of example, the movement directions of the first belt (4) and the second belt (5) have been indicated following the activation in rotation of the two drive pulleys with respective second opposite rotation directions and with a same rotation velocity.

For example, taking as reference FIG. 3, the first drive pulley (40) (also mounted in a lower position in the preferred but not exclusive embodiment) for this purpose it will be activated in an anticlockwise rotation direction while the second drive pulley (5) (also mounted in a lower position in the preferred but not exclusive example) will instead be activated in a clockwise rotation direction, thus generating the movements of the two belts with respect to the central cogged pulley (6) illustrated in FIG. 6B.

In this way, the first belt (4) and the second belt (5) wind about the central cogged pulley (6) according to respective second opposite rotation directions (Z1′, Z2′) (see FIG. 6B once more), thus keeping the central pulley (6) stationary i.e. without rotation, with respect to the respective rotation axis (A) and with respect to the slide (3), consequently pushing the central cogged pulley (6) in an upwards direction (L2) and thus translating the slide (3) upwards along the vertical slot (30), with a respective movement upwards (L2′) of the support element (11) by means of the first member (31) and the lever system (33, 34) (see for example FIG. 2 where the slide (3) is in a raised position with respect to the position of FIG. 3, or FIG. 15 in which the slide is in a raised position with respect to the position of FIG. 10).

In a third possible mode, as illustrated in FIG. 6C, the first drive pulley (40) and the second drive pulley (50) are activatable in rotation with respective first concordant rotation directions (Q1′, Q2′), and with a same rotation velocity.

Similarly to what is done in the preceding modes of activation, FIG. 6 illustrates the movement directions of the first belt (4) and the second belt (5) following the activation in rotation of the two drive pulleys with respective first concordant rotation directions and with a same rotation velocity.

For example, taking FIG. 2 as a reference, the first drive pulley (40) will be activated in an anticlockwise rotation direction while the second drive pulley (50) will also be activated with an anticlockwise rotation direction.

In this way, the first belt (4) and the second belt (5) wind about the central cogged pulley (6) according to respective first concordant winding directions (U1′, U2′), thus causing the central cogged pulley (6) to rotate with respect to the respective rotation axis (A) and with respect to the slide (3) in a first rotation direction (R1) with a consequent rotation (R1′) of the second member (32) and therefore of the support element (11) about the respective longitudinal axis in a first rotation direction (T1) by means of the second member (32) and the lever system (33, 34) (see for example FIGS. 7, 8, 9 and FIGS. 11 and 12).

In a fourth possible mode, the first drive pulley (40) and the second drive pulley (50) are activatable in rotation with respective second concordant rotation directions (Q1′, Q2′), and with a same rotation velocity.

FIG. 6D illustrates the movement directions of the first belt (4) and the second belt (5) following the activation in rotation of the two drive pulleys with respective second concordant directions and with a same rotation velocity.

For example, taking FIG. 2 as a reference, the first drive pulley (40) will be activated in a clockwise rotation direction while the second drive pulley (50) will also be activated with a clockwise rotation direction.

In this way, the first belt (4) and the second belt (5) wind about the central cogged pulley (6) according to respective second concordant winding directions (U1′, U2′), thus causing the central cogged pulley (6) to rotate with respect to the respective rotation axis (A) and with respect to the slide (3) in a second anticlockwise rotation direction (R2) with a consequent rotation of the support element (11) about the respective longitudinal axis in a in a second rotation direction (T2) by means of the second member (32) and the lever system (33, 34) (see for example FIG. 14).

In this way, with the apparatus of the invention it is possible to collect articles in a raised position and bring them and release them, in a lowered position, by causing them to perform a rotation, to arrange them from a vertical position to a horizontal position, and vice versa, for collecting articles from a lowered position and bringing them and releasing them in a raised position, by causing them to perform a rotation to arrange them from a horizontal position to a vertical position, while maintaining and moving the articles in the manoeuvring space comprised between the two vertical bearing columns, and therefore with a particularly reduced size, and leaving the collecting and release areas accessible and visible.

The apparatus can preferably be dimensioned and configured in such a way that the first drive pulley (40) and the second drive pulley (50) of each of the first movement unit (M1) and of the second movement unit (M2) are activatable in rotation according to the first opposite rotation directions (V1′, V2′), according to the second opposite rotation directions (V1″, V2″), according to the first concordant rotation directions (Q1′, Q2′) and according to the second concordant directions (Q1″, Q2″) with respective variable and adjustable rotation velocities in such a way as to move the support element (11), by means of the slide (3), the first member (31), the second member (32) and the lever system (33, 34), according to reciprocally combined translation and rotation movements.

The apparatus of the present invention is further particularly flexible and versatile, in all those cases of size change of the of the articles to be picked up and released.

In fact, simply by activating the first drive pulley and the second drive pulley, in the respective first opposite rotation directions or in the respective second opposite rotation directions, it is possible to height-regulate the position of the slide along the vertical slot present in the two vertical bearing columns, thus going to position the at least a gripping element of the support element in a suitable position, usually median or central, with respect to the position of the articles which are to be collected from a vertical infeeding station in which the articles are arranged in a vertical position.

According to the preferred but not exclusive embodiment embodiment of the apparatus, illustrated in the appended figures, the lever system (33, 34) can preferably comprise a third member (33), hinged, at an end thereof, to the first member (31), and hinged at the other end to the support element (11), and a fourth member (34), hinged, at an end thereof, to the second member (32), and at the other end, to the support element (11), the first member (31), the second member (32), the third member (33) and the fourth member (34) forming a four-bar linkage.

In turn, the first member (31) is conformed in such a way as to comprise a first part (31A), fixed to the slide (3), and a second part (31B), inclined with respect to the first part (31), to which the third member is hinged (33).

The length of the second part (31B) of the first member (31), as also those of the second member (32) and the third (33) and fourth member (24) can be varied in such a way as to be able to suit the movement of the support element to the dimensions and type of the articles, and of the actual position of the infeeding station of the articles in vertical position and of the position of the transport means of the articles in horizontal position.

As illustrated in the figures of the drawings, the first drive pulley (40) and the second drive pulley (50) of each of the first movement unit (M1) and of the second movement unit (M2) are preferably mounted coaxially.

Further, each of the first movement unit (M1) and the second movement unit (M2) can be realised in such a way as each to comprise:

a first return pulley (71) and a second return pulley (72) for the first belt (4), mounted idle on the slide (3) on opposite sides to the central cogged pulley (6) and configured to return the first belt (4) in such a way that the first belt (4) partially winds on a first side of the central cogged pulley (6),

a third return pulley (81) and a fourth return pulley (82) for the second belt (5), mounted idle on the slide (3) on opposite sides to the central pulley (6) and configured to return the second belt (5) in such a way that the second belt (5) partially winds on a second side of the central cogged pulley (6), opposite the first side on which the first belt (4) partially winds.

1) An apparatus for collecting articles from a first position, wherein the articles are arranged vertically, and transferring the articles into a second position wherein the articles are arranged horizontally, and vice versa, comprising:
a first vertical bearing column;
a second vertical bearing column;
wherein the first vertical bearing column and the second vertical bearing column are arranged facing one another and distanced from one another in such a way as to define a manoeuvring space between them;
at least a gripping element, configured such as to pick up, retain and release at least a respective article;
a support element of the at least a gripping element, wherein the support element comprises a longitudinal axis and is arranged in the manoeuvring space between the first vertical bearing column and the second vertical bearing column with the respective longitudinal axis transversally arranged with respect to the first vertical bearing column and to the second vertical bearing column;
a first movement unit, mounted and disposed on the first vertical bearing column, for a movement of the support element;
a second movement unit, mounted and disposed on the second vertical bearing column, for the movement of the support element;
wherein the first movement unit and the second movement unit are configured and activatable to move together the support element:
between a first operating position, in which the at least a gripping element borne by the support element is opposite the at least a respective article to be picked up and which is situated in the first position wherein the at least a respective article is vertically arranged, for the pick-up of the at least a respective article by the gripping element, and a second operating position wherein the gripping element borne by the support element is opposite a transport means with the at least a respective article retained by the gripping element being arranged in the second position and horizontally, for release thereof onto the transport means,
wherein the first movement unit and the second movement unit are configured and activatable to move, together, the support element between the first operating position and the second operating position, while keeping the support element arranged in the manoeuvring space and causing the support element to perform a rotation about the respective longitudinal axis in such a way as to rotate the at least a respective article retained by the gripping element between a vertical position and a horizontal position, and vice versa.

2) The apparatus as claimed in claim 1, wherein the first movement unit and the second movement unit are realised in such a way as each to comprise:
a slide, mounted translatably in a vertical slot realised respectively in both the first vertical bearing column and in the second vertical bearing column;
a first member, rigidly mounted on the slide;
a second member, rotatably hinged to the slide according to a respective rotation axis;
a lever system, rotatably coupled, on one side, to the first member and to the second member, and hinged, on the other side, to the support element of the at least a gripping element;
a first belt, closed loop-wound on a first drive pulley and a first driven pulley which are mounted on the first vertical bearing column and on the second vertical bearing column on opposite sides with respect to the vertical slot;
a second belt, closed loop-wound on a second drive pulley and a second driven pulley which are mounted on the first vertical bearing column and on the second vertical bearing column, on opposite sides with respect to the vertical slot;
a central cogged pulley, rotatably mounted on the slide at the respective rotation axis of the second member in such a way as to rotate the second member when the central cogged pulley is activated in rotation,
wherein the central cogged pulley is mounted on the slide in a position interposed between the first drive pulley and the first driven pulley, and between the second drive pulley and the second driven pulley, and wherein the first belt is configured and arranged in such a way as to partially wind on a first side of the central cogged pulley, and wherein the second belt is arranged and configured in such a way as to partially wind on a second side of the central cogged pulley, opposite the first side on which the first belt partially winds.

3) The apparatus as claimed in claim 2, wherein the first drive pulley and the second drive pulley are activatable independently of one another according to any one, also in any combination of following ways:
the first drive pulley and the second drive pulley are activatable in rotation with respective first opposite rotation directions, and with a same rotation velocity, in such a way that the first belt and the second belt wind about the central cogged pulley according to respective first opposite rotation directions while keeping the central cogged pulley stationary, i.e. without rotation, with respect to the respective rotation axis and with respect to the slide, thus pushing the central cogged pulley in a downwards direction and thus translating the slide downwards along the vertical slot present in the first vertical bearing column and in the second vertical bearing column, with a consequent downwards-movement downwards of the support element by means of the first member and the lever system;
the first drive pulley and the second drive pulley are activatable in rotation with respective second opposite rotation directions and with a same rotation velocity, in such a way that the first belt and the second belt wind about the central cogged pulley according to respective second opposite rotation directions, thus keeping the central pulley stationary i.e. without rotation, with respect to the respective rotation axis and with respect to the slide, pushing the central cogged pulley in an upwards direction and thus translating the slide upwards along the vertical slot, with a consequent movement upwards of the support element by means of the first member and the lever system; the first drive pulley and the second drive pulley are activatable in rotation with respective first concordant rotation directions and with a same rotation velocity, in such a way that the first belt and the second belt wind about the central cogged pulley according to respective first concordant winding directions thus causing the central cogged pulley to rotate with respect to the respective rotation axis and with respect to the slide in a first rotation direction with a consequent rotation of the second member and therefore of the support element about the respective longitudinal axis in the first rotation direction by means of the second member and the lever system;
the first drive pulley and the second drive pulley are activatable in rotation with respective second concordant rotation directions and with a same rotation velocity, in such a way that the first belt and the second belt wind about the central cogged pulley with respective second concordant winding directions thus causing the central cogged pulley to rotate with respect to the respective rotation axis and with respect to the slide in a second rotation direction with a consequent rotation of the support element about the respective longitudinal axis in the second rotation direction by means of the second member and the lever system

4) The apparatus as claimed in claim 3, wherein the first drive pulley and the second drive pulley of each of the first movement unit and of the second movement unit are activatable in rotation according to the first opposite rotation directions according to the second opposite rotation directions according to the first concordant rotation directions and according to the second concordant directions with respective variable and adjustable rotation velocities in such a way as to move the support element, by means of the slide, the first member, the second member and the lever system, according to reciprocally combined translation and rotation movements.

5) The apparatus as claimed in claim 2, wherein the lever system comprises a third member, hinged, at an end thereof, to the first member, and hinged at the other end to the support element, and a fourth member, hinged, at an end thereof, to the second member, and at the other end, to the support element, the first member, the second member, the third member and the fourth member forming a four-bar linkage.

6) The apparatus as claimed in claim 5, wherein the first member is conformed in such a way as to comprise a first part, fixed to the slide, and a second part, inclined with respect to the first part, to which the third member is hinged.

7) The apparatus as claimed in claim 2, wherein the first drive pulley and the second drive pulley of each of the first movement unit and of the second movement unit are mounted coaxially.

8) The apparatus as claimed in claim 2, wherein each of the first movement unit and of the second movement unit comprises:
a first return pulley and a second return pulley for the first belt, mounted idle on the slide on opposite sides to the central cogged pulley and configured to return the first belt in such a way that the first belt partially winds on the first side of the central cogged pulley,
a third return pulley and a fourth return pulley for the second belt, mounted idle on the slide on opposite sides to the central cogged pulley and configured to return the second belt in such a way that the second belt partially winds on the second side of the central cogged pulley, opposite the first side on which the first belt partially winds.
